(19) United States
(12) Patent Application Publication
(10) Pub. No.: US 2025/0254549 A1
(43) Pub. Date: Aug. 7, 2025

(54) INFORMATION TRANSCEIVING METHOD AND APPARATUS

(71) Applicant: FUJITSU LIMITED, Kawasaki-shi (JP)

(72) Inventors: Gang SUN, Beijing (CN); Xin WANG, Beijing (CN)

(73) Assignee: FUJITSU LIMITED, Kawasaki-shi (JP)

(21) Appl. No.: 19/191,091

(22) Filed: Apr. 28, 2025

Related U.S. Application Data
(63) Continuation of application No. PCT/CN2022/129856, filed on Nov. 4, 2022.

(51) Int. Cl. H04W 24/08

(52) U.S. Cl. CPC H04W 24/08

(57) ABSTRACT

An information transceiving apparatus, applicable to a network device, includes: a first transmitter configured to transmit configuration parameters for monitoring performances of one or more AI models to a terminal equipment; and a first receiver configured to receive performance monitoring results of the one or more AI models transmitted by the terminal equipment.

### CROSS-REFERENCE TO RELATED APPLICATION

This application is a continuation application under 35 U.S.C. 111 (a) of International Patent Application PCT/CN2022/129856 filed on Nov. 4, 2022, and designated the U.S., the entire contents of which are incorporated herein by reference.

### TECHNICAL FIELD

This disclosure relates to the field of communication technologies.

### BACKGROUND

As low-frequency spectrum resources become scarce, millimeter wave bands are able to provide greater bandwidths and have become important frequency bands for 5G NR (New Radio) systems. As millimeter waves are relatively short in wavelengths and have propagation characteristics different from legacy low-frequency bands, such as higher propagation loss, and poor reflection and diffraction performances, etc., larger scales of antenna arrays are usually used to form shaped beams with greater gains, overcome propagation losses, and ensure system coverage. 5G NR standards have designed a series of solutions for beam management, including beam scanning, beam measurement, beam report, and beam indication, etc. However, when the number of receiving beams and transmitting beams is relatively large, the payload and latency of the system will be greatly increased.

With the development of artificial intelligence (AI) technologies, applying the AI technologies to physical layers of wireless communication to solve difficulties of legacy methods has become a current technological direction. For the beam management, using AI models to predict a spatially optimal beam pair according to results of measurement of a small number of beams may significantly reduce the payload and latency of the system.

It should be noted that the above description of background is merely provided for clear and complete explanation of this disclosure and for easy understanding by those skilled in the art. And it should not be understood that the above technical solution is known to those skilled in the art as it is described in the background of this disclosure.

### SUMMARY

Assuming that a transmitting end of a communication system has M beams and a receiving end thereof has N beams, in existing standards, it is needed to measure M*N beams. When values of M and N are relatively large, measuring M*N beams results in a relatively large system payload and relatively long latency. Using models (such as AI models) to predict an optimal beam pair with results of measurement of a small number of beams may greatly reduce the system payload and latency caused by the beam measurement.

It was found by the inventors that in using an AI model for beam prediction, due to frequent changes in the communication environment, if the AI model is not suitable for the current communication environment, it causes a decrease in communication performance. In this case, it may be backed off to a legacy beam management method or reselect an AI model or retrain the AI model; in addition, if the system operates in a legacy beam management state, when the AI model is suitable for the current communication environment, the system may enter a state of using the AI model for beam prediction. The above process is dependent on performance monitoring of AI models in different communication environments. Therefore, how to monitor performances of AI models has become an urgent problem to be solved, and currently, there is no relevant discussion. In order to solve at least one of the above problems, embodiments of this disclosure provide an information transceiving method and apparatus.

According to one aspect of the embodiments of this disclosure, there is provided an information transceiving apparatus, applicable to a network device, the apparatus including:
a first transmitting unit configured to transmit configuration parameters for monitoring performances of one or more AI models to a terminal equipment; and
a first receiving unit configured to receive performance monitoring results of one or more AI models transmitted by the terminal equipment.

According to another aspect of the embodiments of this disclosure, there is provided an information transceiving apparatus, applicable to a terminal equipment, the apparatus including:
a second receiving unit configured to receive configuration parameters transmitted by a network device for monitoring performances of one or more AI models; and
a second transmitting unit configured to transmit performance monitoring results of one or more AI models to the network device.

According to a further aspect of the embodiments of this disclosure, there is provided a communication system, including a terminal equipment and/or a network device, the terminal equipment including the information transceiving apparatus described in the one aspect, and the network device including the information transceiving apparatus described in the other aspect.

An advantage of the embodiments of this disclosure exists in that the network device transmits the configuration parameters for monitoring performances of one or more AI models to the terminal equipment. Hence, the terminal equipment may generate performance monitoring results according to the configuration parameters, and may effectively monitor the performances of the AI model according to the performance monitoring results, which is helpful to select a beam management mode suitable for current communication environment, thereby reducing system payload and latency.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/comprising/including/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is schematic diagram of a communication system of embodiments of this disclosure;

FIG. 2 is a schematic diagram of a transmitting beam and a receiving beam in the communication system of the embodiments of this disclosure;

FIG. 3 is a schematic diagram of an information transceiving method of embodiments of this disclosure;

FIG. 4 is a schematic diagram of transmitting beams and receiving beams of an embodiment of this disclosure;

FIG. 5 is a schematic diagram of an information transceiving method of embodiments of this disclosure;

FIG. 6 is a schematic diagram of an information transceiving method of embodiments of this disclosure;

FIG. 7 is a schematic diagram of an information transceiving apparatus of embodiments of this disclosure;

FIG. 8 is a schematic diagram of an information transceiving apparatus of embodiments of this disclosure;

FIG. 9 is a schematic diagram of a network device of embodiments of this disclosure; and

FIG. 10 is a schematic diagram of a terminal equipment of embodiments of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, 5G, new radio (NR) and 6G in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, an industrial wireless device, a surveillance camera, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipment described above. “A device” may refer to a network device, and may also refer to a terminal equipment, except otherwise specified.

In the following description, without causing confusion, the terms “uplink control signal” and “uplink control information (UCI)” or “physical uplink control channel (PUCCH)” are interchangeable, and terms “uplink data signal” and “uplink data information” or “physical uplink shared channel (PUSCH)” are interchangeable.

The terms “downlink control signal” and “downlink control information (DCI)” or “physical downlink control channel (PDCCH)” are interchangeable, and the terms “downlink data signal” and “downlink data information” or “physical downlink shared channel (PDSCH)” are interchangeable.

In addition, transmitting or receiving a PUSCH may be understood as transmitting or receiving uplink data carried by the PUSCH, transmitting or receiving a PUCCH may be understood as transmitting or receiving uplink information carried by the PUCCH, transmitting or receiving a PRACH may be understood as transmitting or receiving a preamble carried by the PRACH. The uplink signal may include an uplink data signal and/or an uplink control signal, etc., and may be referred to as uplink transmission or uplink information or an uplink channel. Transmitting uplink transmission on an uplink resource may be understood as transmitting the uplink transmission by using the uplink resource. Likewise, downlink data/signal/channel/information may be understood correspondingly.

In the embodiments of this disclosure, higher-layer signaling may be, for example, radio resource control (RRC) signaling; for example, it is referred to an RRC message, which includes an MIB, system information, and a dedicated RRC message; or, it is referred to as an RRC information element (RRC IE). Higher-layer signaling may also be, for example, medium access control (MAC) signaling, or an MAC control element (MAC CE); however, this disclosure is not limited thereto.

Scenarios in the embodiments of this disclosure shall be described below by way of examples; however, this disclosure is not limited thereto.

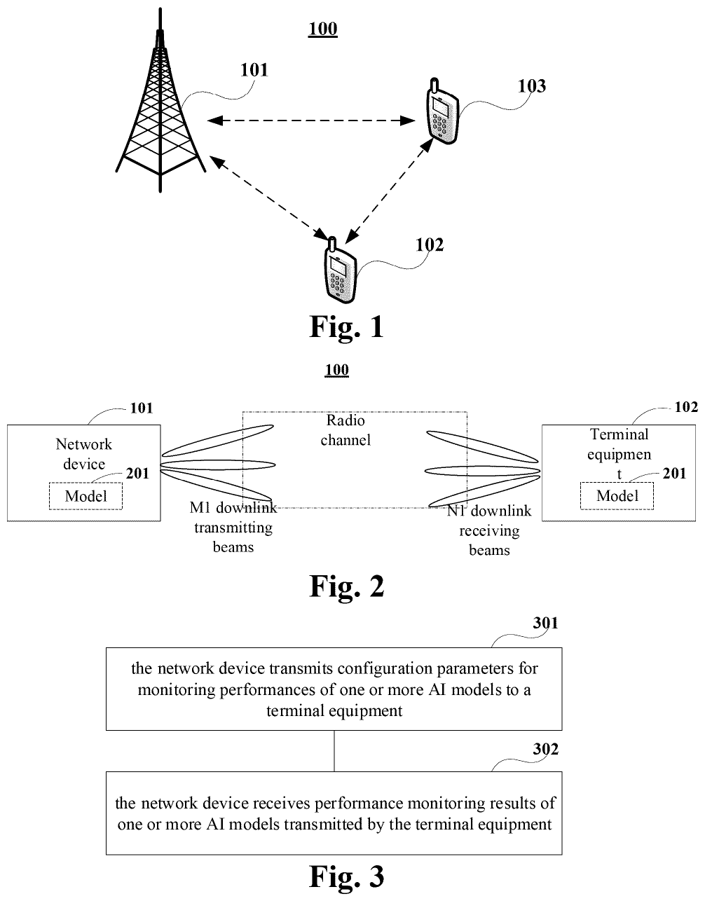

FIG. 1 is a schematic diagram of a communication system of embodiments of this disclosure, in which a case where terminal equipments and a network device are taken as examples is schematically shown. As shown in FIG. 1, a communication system 100 may include a network device 101 and terminal equipments 102, 103. For the sake of simplicity, an example having only two terminal equipments and one network device is schematically given in FIG. 1; however, the embodiments of this disclosure are not limited thereto.

In the embodiments of this disclosure, existing services or services that may be implemented in the future may be performed between the network device 101 and the terminal equipments 102, 103. For example, such services may include but not limited to an enhanced mobile broadband (eMBB), massive machine type communication (mMTC), and ultra-reliable and low-latency communication (URLLC), etc.

The terminal equipment 102 may transmit data to the network device 101, such as in a granted or grant-free transmission manner. The network device 101 may receive data transmitted by one or more terminal equipments 102 and feed back information to the terminal equipment 102, such as acknowledgement (ACK)/non-acknowledgement (NACK) information. According to the feedback information, the terminal equipment 102 may acknowledge end of a transmission process, or may perform new data transmission, or may perform data retransmission.

It should be noted that FIG. 1 shows that two terminal equipments 102, 103 are both in coverage of the network device 101. However, this disclosure is not limited thereto, and the two terminal equipments 102, 103 may not be in coverage of the network device 101, or one terminal equipment 102 is in coverage of the network device 101 and the other terminal equipment 103 is out of coverage of the network device 101.

An AI model (or an ML model) includes but is not limited to an input layer (input), multiple convolutional layers, a concatenation layer (concat), a fully connected layer (FC), and a quantizer, etc., and processing results of the multiple convolutional layers are merged in the concatenation layer. Reference may be made to existing techniques for a specific structure of the AI model, which shall not be repeated herein any further.

FIG. 2 is a schematic diagram of a transmitting beam and a receiving beam in the communication system of the embodiments of this disclosure. As shown in FIG. 2, in the communication system 100, taking a downlink channel as an example, the network device 101 may have M1 downlink transmitting beams DL TX, and the terminal equipment 102 may have N1 downlink receiving beams DL RX.

In the embodiments of this disclosure, as shown in FIG. 2, a model 201 for predicting a beam measurement result may be deployed in the network device 101 or the terminal equipment 102. The model 201 may predict measurement results of M1*N1 beams according to measurement results of a part of beams. The model 201 may be, for example, an AI model.

In addition, for an uplink channel, the network device 101 may have N2 uplink receiving beams (not shown in FIG. 2), and the terminal equipment 102 may have M2 uplink transmitting beams UL TX (not shown in FIG. 2).

Following description shall be given with reference to the accompanying drawings and embodiments.

### Embodiments of a First Aspect

The embodiments of this disclosure provide an information transceiving method, which shall be described from a network device side.

FIG. 3 is a schematic diagram of the information transceiving method of the embodiments of this disclosure. As shown in FIG. 3, the method includes:
301: the network device transmits configuration parameters for monitoring performances of one or more AI models to a terminal equipment; and
302: the network device receives performance monitoring results of one or more AI models transmitted by the terminal equipment.

It should be noted that FIG. 3 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 3.

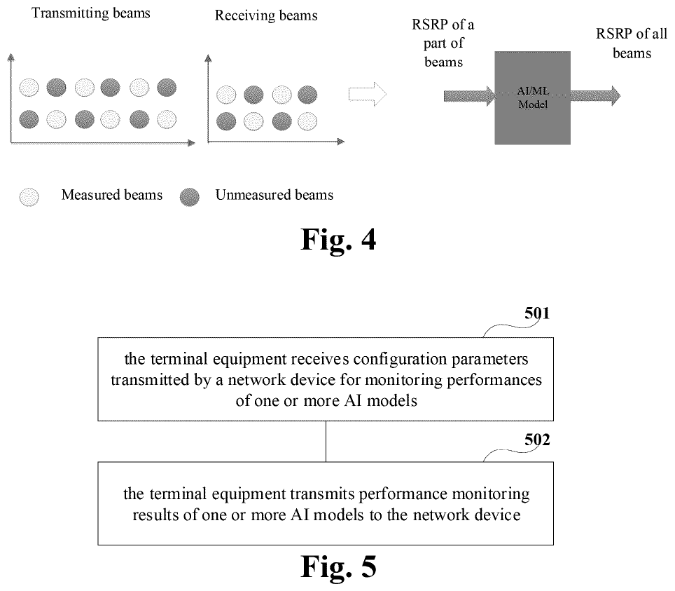

In some embodiments, the AI model for beam prediction is deployed in the terminal equipment, and an optimal beam pair is predicted by using the AI model according to measurement results of a small number of beam pairs. Input parameters of the AI model are RSRP (reference signal receiving power) values of a part of beam pairs, and may also be SINR (signal to interference plus noise ratio) values of a part of beam pairs, and output quantities are RSRP or SINRs of all beam pairs. FIG. 4 is a schematic diagram of the transmitting beams, receiving beams and AI model in the embodiments of this disclosure. As shown in FIG. 4, for example, there are 12 downlink transmitting beams, 8 downlink receiving beams and total 96 beam pairs. Through configuration, the terminal equipment only measures RSRP of 24 beam pairs (6 downlink transmitting beams and 4 downlink receiving beams). At this moment, a dimension of the input parameters of the AI model is 24, and input quantity is RSRP or SINR, and a dimension of the output parameters is 96, a output quantity is also RSRP or SINR, and the optimal beam pair may be selected from a result of prediction.

In some embodiments, one or more AI models may be pre-deployed in the terminal equipment, and in order to monitor performances of the deployed AI models, the network device transmits the configuration parameters for monitoring performances of one or more AI models to the terminal equipment. Hence, the terminal equipment may generate performance monitoring results according to the configuration parameters, and may effectively monitor the performances of the AI models according to the performance monitoring results, which is helpful to select a beam management mode suitable for current communication environment, thereby reducing system payload and latency.

In some embodiments, the method further includes (not shown): activating or deactivating the AI model or selecting an AI model or switching the AI model according to the performance monitoring results. The configuration parameters include a first configuration parameter used to determine to activate an AI model, and/or a second configuration parameter used to determine to deactivate an AI model, and/or a third configuration parameter used to select an AI model and/or switch an AI model. That is, the network device may simultaneously transmit the above three types of configuration parameters, or may also transmit at least one type of the three types of configuration parameters according to a state of the system. The first configuration parameter, the second configuration parameter and the third configuration parameter are identical or different, and shall be described below in detail.

In some embodiments, when an AI model is pre-deployed in the terminal equipment, the system may be in an activated state of the AI model (that is, the AI model is used for performing beam prediction, or the AI model is working), the network device may transmit the configuration parameters for monitoring the performance of the AI model (hereinafter also referred to as configuration parameters for determining deactivation, or second configuration parameters), the terminal equipment may generate the performance monitoring results according to the configuration parameters, and the network device determines whether to deactivate the AI model based on the performance monitoring results (e.g. resuming to a legacy beam management state).

In some embodiments, when an AI model is pre-deployed in the terminal equipment, the system may be in a deactivated state of the AI model (a legacy beam management state), the network device may transmit the configuration parameters for monitoring the performance of the AI model (hereinafter also referred to as configuration parameters for determining activation, or first configuration parameters), the terminal equipment may generate performance monitoring results according to the configuration parameters, and the network device determines whether to activate the AI model based on the performance monitoring results (such as resuming to a state of using the AI model for performing beam prediction or entering the activated state of AI model or AI model working state by the system).

In some embodiments, when multiple AI models are pre-deployed in the terminal equipment, the system may be in a deactivated state of the AI model (a legacy beam management state) or an activated state of the AI model (using a AI model for beam prediction, or an AI model is working), the network device may transmit configuration parameters (including the above first configuration parameter or the second configuration parameter) for monitoring the performance of one of the AI models, the terminal equipment may generate performance monitoring results according to the configuration parameters, and the network device determines whether to deactivate the AI model based on the performance monitoring results (such as resuming to the legacy beam management state, based on the second configuration parameter), or determines whether to activate the AI model (such as resuming to the state of using an AI model for beam prediction or entering an activated state of the AI model or AI model working state by the system, based on the first configuration parameter) based on the performance monitoring results.

In the above embodiments, the first configuration parameter and the second configuration parameter may be transmitted to the terminal equipment simultaneously, or only one of them may be transmitted according to a state of the system. For example, when the system is in the activated state of the AI model, the second configuration parameter is transmitted, and when the system is in the deactivated state of the AI model, the first configuration parameter is transmitted, and the embodiments of this disclosure are not limited thereto. For example, the information transmitted by the network device to the terminal equipment is configuration parameters of one AI model, the configuration parameters including a first configuration parameter and/or a second configuration parameter, which may be identical or different.

In some embodiments, when multiple AI models are pre-deployed in the terminal equipment, the system may be in the deactivated state of the AI model (the legacy beam management state) or the activated state of the AI model (using one AI model for beam prediction, or one of the AI models is working), the network device may transmit configuration parameters for monitoring performances of the multiple AI models (including the second configuration parameter or a configuration parameter for selecting an AI model and/or switching an AI model, i.e. a third configuration parameter), the terminal equipment may generate performance monitoring results according to the configuration parameters, and the network device determines whether to select an AI model to enter the working state based on the performance monitoring results (originally in the deactivated state, based on the third configuration parameter), or determines whether to switch the AI model for beam prediction (originally in an activated state of the AI model, based on the third configuration parameter), or whether to deactivate the AI model (such as resuming to the legacy beam management state, based on the second configuration parameter).

In the embodiments, the third configuration parameter and the second configuration parameter may be transmitted to the terminal equipment simultaneously, or only one of them may be transmitted according to a state of the system; and on the other hand, configuration parameters of AI models in the multiple AI models for monitoring performances may be transmitted to the terminal equipment simultaneously, or may be transmitted to the terminal equipment separately in multiple times, which shall not be enumerated herein any further.

In the embodiments, when the network device transmits the configuration parameters for monitoring the performances of the multiple AI models, the configuration parameters for monitoring the performances of different AI models may be identical or different. For example, when the configuration parameters are identical, only one set of configuration parameters for all the AI models may be transmitted, that is, the information transmitted by the network device to the terminal equipment is: configuration parameters; and when the configuration parameters are different, the network device may also transmit identifiers of AI models corresponding to the configuration parameters, so as to distinguish configuration parameters configured for different AI models. For example, the information transmitted by the network device to the terminal equipment is: an identifier of AI model 1, a configuration parameter 1 of AI model 1, an identifier of AI model 2, a configuration parameter 2 of AI model 2, an identifier of AI model 3, a configuration parameter 3 of AI model 3 . . . . The above information may be transmitted simultaneously or in multiple times. For example, the identifier of AI model 1 and the configuration parameter 1 of AI model 1 are transmitted at a first time, the identifier of AI model 2 and the configuration parameter 2 of AI model 2 are transmitted at a second time, the identifier of AI model 3 and the configuration parameter 3 of AI model 3 are transmitted at a third time, and so on. The above configuration parameters may include the second configuration parameter and/or the third configuration parameter, and the third configuration parameter and the second configuration parameter may be identical or different.

The following description shall be given by taking a configuration parameter for monitoring performances of one AI model as an example. It should be noted that the following description is applicable to the first configuration parameter, the second configuration parameter and third configuration parameter, and is also applicable to configuration parameters of other AI models for monitoring performances.

Following is the detailed description.

In some embodiments, the configuration parameters include a threshold for performance metric and/or a filter coefficient for performance metric and/or a counter for counting a monitoring result of a performance metric. The above performance metric includes a prediction error and/or a prediction accuracy and/or a throughput, and/or a frame error rate, which shall be described below respectively.

In some embodiments, an input of the AI model is measurement results of a part of beams (pairs), an output of the AI model may include predicted results of the beams (pairs) and identification information of corresponding beams (pairs). There may exist errors between the predicted values and actual measured values, and the errors may be used to evaluate quality of the AI model. Hence, the prediction error or the prediction accuracy may be taken as the performance metric.

For example, the prediction error includes a difference between a predicted result of an optimal beam (pair) outputted by the AI model and an actual measured result of the optimal beam (pair). That is, the prediction error is a difference between a predicted result output by an AI model and the actual measured result corresponding to identical optimal beams.

For example, the prediction error includes a difference between a predicted result of a first optimal beam (pair) outputted by the AI model and an actually measured result of a second optimal beam (pair). The first optimal beam (pair) is an optimal beam (pair) output by the AI model, the second optimal beam (pair) is an actually measured optimal beam (pair), and the first optimal beam (pair) and the second optimal beam (pair) may be identical or different.

For example, the prediction error includes an average value of differences between predicted results of multiple beams (pairs) outputted by the AI model and actually measured results of the multiple beams (pairs). That is, the prediction error is an average value of differences between predicted results output by the AI model and the actually measured results corresponding to identical multiple beams (pairs). The multiple beams may be K beams (pairs) with largest measurement results; however, the embodiments of this disclosure are not limited thereto. For example, the predicted results of the multiple beams (pairs) are B1, B2, . . . , BK, the actually measured results are A1, A2, . . . , AK, and the prediction error is (B1−A1+B2−A2+ . . . +BK−AK)/K. For example, the prediction error includes an average value of differences between predicted results of multiple first beams (pairs) outputted by an AI model and actually measured results of second optimal beams (pairs) correspond. The first beams (pairs) are multiple (K) beams (pairs) output by the AI model with, for example, largest predicted results, and the second beams (pairs) are actually measured multiple (K) beams (pairs) with, for example, largest predicted results, and the first beams (pairs) and the second beams (pairs) may be identical or different. For example, the predicted results of the beams (pairs) are B1, B2, . . . , BK, the actual measured results of the second beams (pairs) are A1, A2, . . . , AK, and the prediction error is (B1−A1+B2−A2+ . . . +BK−AK)/K.

For example, the prediction accuracy includes a first probability of whether a first optimal beam (pair) outputted by the AI model is identical to an actually measured second optimal beam (pair), or a second probability that a first number of first beams (pairs) outputted by the AI model contain actually measured optimal beams (pairs), or a third probability that optimal beams (pairs) outputted by the AI model are contained in a second number of actually measured second beams (pairs). Description of the first beam (pair) and the second beam (pair) is as described above, which shall not be repeated herein any further. The above probabilities may be counted with multiple AI model inference instances. For example, the first probability is counted with MAI model inference instances. For example, in the M AI model inference instances, first optimal beams (pairs) and second optimal beams (pairs) of M−2 inference instances are identical, first optimal beams (pairs) and second optimal beams (pairs) of 2 inference instances are not identical, and the first probability is (M−2)/M. A method for counting the second probability is similar to that for counting the third probability, which shall not be enumerated herein any further.

In some embodiments, the above measured results and/or predicted results include L1-RSRP or SINR; however, the embodiments of this disclosure are not limited thereto. The above actual measured results are determined according to training data of the AI model or according to actual measured results when the AI model is not applied. That is, the actually measured L1-RSRP or SINR above may be label data measured during a training period of the AI model, or may also be historical measurement data (such as measurement data when a legacy beam management state is used when an AI model is not applied).

In some embodiments, the performance metric may include a throughput and/or a frame error rate. Reference may be made to existing technologies for methods for calculating the throughput and frame error rate, which shall not be enumerated herein any further.

In some embodiments, the threshold in the configuration parameters is used to compare with a value of a performance metric calculated by the terminal equipment, so as to determine whether the performance of the AI model may satisfy performance requirements and achieve monitoring of the performance of the AI model. In addition, when the communication environment changes frequently or there exists a calculation error in calculating the value of the performance metric by the terminal side, it causes frequent switching (activation/deactivation of the AI model) of determination of whether a current AI model is suitable by the system in beam management, which affects payload of system signaling and delay of communication. Filter coefficients and/or counters are used to filter the calculated value of the performance metric, and whether the performance of the AI model satisfies the performance requirements may be determined according to the filtered value of the performance metric. Hence, frequent switching of the AI model between activation and deactivation may be avoided. How to apply the threshold, the filter coefficients and the counter shall be described below in the embodiments of a second aspect.

In some embodiments, the configuration parameters are carried by RRC or an MAC CE or DCI. For example, the threshold, the filter coefficient and/or the counter may be represented by a bit sequence of a predetermined number of bits, and decimal values to which the bit sequence corresponds are threshold, the filter coefficient and/or the counter. Information elements may be newly added to existing RRC or MAC CE or DCI to carry the configuration parameters, or existing information elements in existing RRC or MAC CE or DCI may carry the configuration parameters, or new RRC or MAC CE or DCI may be designed to carry the configuration parameters; however, the embodiments of this disclosure are not limited thereto.

In some embodiments, in 302, the terminal equipment may generate the performance monitoring results based on the configuration parameters and report them to the network device. The performance monitoring results include AI model performance indication information, and/or the value of the performance metric of the AI model, and/or the identifier of the AI model, which shall be described below in the embodiments of the second aspect.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

The network device transmits the configuration parameters for monitoring performances of one or more AI models to the terminal equipment. Hence, the terminal equipment may generate performance monitoring results according to the configuration parameters, and may effectively monitor the performances of the AI model according to the performance monitoring results, which is helpful to select a beam management mode suitable for current communication environment, thereby reducing system payload and latency.

### Embodiments of the Second Aspect

The embodiments of this disclosure provide an information transceiving method, which shall be described from a terminal equipment side, with contents identical to those in the embodiment of the first aspect being not going to be described herein any further.

FIG. 5 is a schematic diagram of the information transceiving method of the embodiments of this disclosure. As shown in FIG. 5, the method includes:
501: the terminal equipment receives, configuration parameters transmitted by a network device for monitoring performances of one or more AI models; and
502: the terminal equipment transmits performance monitoring results of one or more AI models to the network device.

It should be noted that FIG. 5 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 5.

In some embodiments, reference may be made to the embodiments of the first aspect for implementations of the above configuration parameters, and implementation of 501 corresponds to that of 301, which shall not be repeated herein any further.

As described above, the threshold in the configuration parameters is used to compare with a value of a performance metric calculated by the terminal equipment, so as to determine whether the performance of the AI model may satisfy performance requirements and achieve monitoring of the performance of the AI model.

For example, when the performance metric is a prediction error, when a value of the prediction error is greater than a threshold for the prediction error, it indicates that the performance of the AI model does not satisfy the performance requirements. When the value of the prediction error is less than the threshold for the prediction error, it indicates that the performance of the AI model satisfies the performance requirements. When the performance metric is a prediction accuracy, when a value of the prediction accuracy is greater than a threshold for the prediction accuracy, it indicates that the performance of the AI model satisfies the performance requirements. If the value of the prediction accuracy is less than the threshold for prediction accuracy, it indicates that the performance of the AI model does not satisfy the performance requirements.

As described above, the filter coefficient in the configuration parameters is used to filter the calculated value of the performance metric and determine whether the performance of the AI model satisfies the performance requirements according to the filtered value of the performance metric. Hence, frequent switching of the AI model between activation and deactivation may be avoided.

For example, a filtering formula is as follows:

$${F}_{n} = ( 1 - a ) \times {F}_{n - 1} + a \times {M}_{n} ;$$

where, α is the filter coefficient in the configuration parameters transmitted by the network side, Mₙ is a value of the performance metric calculated in latest AI model inference, for example, Fₙ is a value of an updated filtered performance metric, Fₙ₋₁ is a value of the performance metric after last filtering, and n denotes the number of times of filtering.

For example, when the performance metric Mₙ is the prediction error, if the value of the filtered prediction error Fₙ is greater than the threshold for the prediction error, it indicates that the performance of the AI model does not satisfy the performance requirements, and if the value of the filtered prediction error Fₙ is less than the threshold for the prediction error, it indicates that the performance of the AI model satisfies the performance requirements; when the performance metric Mₙ is the prediction accuracy, when the value of the filtered prediction accuracy Fₙ is greater than the threshold for the prediction accuracy, it indicates that the AI model performance satisfies the performance requirements; and when the value of the filtered prediction accuracy Fₙ is less than the threshold for the prediction accuracy, it indicates that the AI model performance does not satisfy the performance requirements.

As described above, the counter in the configuration parameters is used to filter the calculated value of the performance metric and determine whether the performance of the AI model may satisfy the performance requirements according to the value of the filtered performance metric. Hence, frequent switching of the AI model between activation and deactivation may be avoided.

For example, the counter in the configuration parameters transmitted by network devices is a counter of N bits, and a maximum count value thereof is set to be Y. When the performance metric Mₙ is the prediction error, when a value of the prediction error Mₙ is greater than the threshold for the prediction error, the counter is increased by 1, and when the value of the prediction error Mₙ is less than the threshold for the prediction error, the counter is decreased by 1, and so on, until the counter reaches the set maximum count value, and vice versa (specific cases are related to a state of the system). When the performance metric Mₙ is a prediction accuracy, when a value of the prediction accuracy Mₙ is greater than the threshold for the prediction accuracy, counter is increased by 1, and when the value of the prediction accuracy Mₙ is less than the threshold for the prediction accuracy, the counter is decreased by 1, and so on, until the counter reaches the set maximum count value, and vice versa (specific cases are related to a state of the system).

Meanings of the configuration parameters are described above, and how to generate the performance monitoring results shall be described below.

In some embodiments, the performance monitoring results include AI model performance indication information, and/or a value of an AI model performance metric, and/or an identifier of an AI model.

In some embodiments, the terminal equipment may calculate the value of the performance metric and transmit a performance monitoring result containing the value of the performance metric to the network device, and the network device determines whether the performance of the AI model is able to satisfy the performance requirements, thereby activating the AI model or deactivating the AI model or selecting an AI model or switching the AI model; or, the terminal equipment may calculate the value of the performance metric, determine whether the performance of the AI model is able to satisfy the performance requirements, generate a performance monitoring result containing AI model performance indication information and transmit it to the network device. The network device activates the AI model or deactivates the AI model or select an AI model or switch the AI model according to the performance monitoring result. When multiple AI models are deployed in the terminal equipment and performance monitoring results of the multiple AI models are different, the performance monitoring results may further include identifiers of the AI models, so as to distinguish performance monitoring results of different AI models, which shall be described below respectively.

### (I) The Terminal Equipment Determines Whether the Performance of the AI Model Satisfies the Performance Requirements

In some embodiments, the terminal equipment may filter the value of the performance metric, and/or compare the value of the performance metric (before or after filtering) with the configuration parameters (the threshold), according to the configuration parameters (the filter coefficients and/or the counter), and generate the performance monitoring results containing the AI model performance indication information according to a filtering result and/or a comparison result.

In some embodiments, the configuration parameters include the threshold, and the terminal equipment may calculate the value of the performance metric. The terminal equipment compares the value with the threshold and generates the AI model performance indication information according to the comparison result. The AI model performance indication information is used to indicate whether the performance of the AI model satisfies the performance requirements, and may be represented by information of 1 bit.

For example, when the system is in the activated state of the AI model, the configuration parameter is the second configuration parameter. When the performance metric is a prediction error, when a value of the prediction error is greater than the threshold for the prediction error, it indicates that the performance of the AI model does not satisfy the performance requirements, that is, a current AI model is no longer suitable for the communication environment. The terminal equipment generates the AI model performance indication information (with a bit value of 1) and takes it as the performance monitoring result to indicate that the AI model performance does not satisfy the performance requirements. In other words, when the value of the prediction error is greater than the threshold for the prediction error, one instance of reporting of the performance monitoring result is triggered. When the network device receives the performance monitoring result and learns that the performance of the AI model does not satisfy the performance requirements, and determines whether to deactivate the AI model. That is, when the value of the prediction error is less than the threshold, AI model performance indication information is not generated, and no performance monitoring result is reported.

For example, when the system is in the deactivated state of the AI model, the configuration parameter is the first configuration parameter. When the performance metric is a prediction error, when a value of the prediction error is less than the threshold for the prediction error, it indicates that the performance of the AI model satisfies the performance requirements, that is, a current AI model is suitable for the communication environment. The terminal equipment generates the AI model performance indication information (with a bit value of 1) and takes it as the performance monitoring result to indicate that the AI model performance satisfies the performance requirements. In other words, when the value of the prediction error is less than the threshold for the prediction error, one instance of reporting of the performance monitoring result is triggered. When the network device receives the performance monitoring result and learns that the performance of the AI model satisfies the performance requirements, and determines whether to activate the AI model (enter the activated state of the AI model). That is, when the value of the prediction error is greater than the threshold, AI model performance indication information is not generated, and no performance monitoring result is reported.

For example, when the system is in the activated state of the AI model, the configuration parameter is the second configuration parameter. When the performance metric is a prediction accuracy, when a value of the prediction accuracy is less than the threshold for prediction accuracy, it indicates that the performance of the AI model does not satisfy the performance requirements, that is, a current AI model is no longer suitable for the communication environment. The terminal equipment generates the AI model performance indication information (with a bit value of 1) and takes it as the performance monitoring result to indicate that the AI model performance does not satisfy the performance requirements. In other words, when the value of the prediction accuracy is less than the threshold for prediction accuracy, one instance of reporting of the performance monitoring result is triggered. When the network device receives the performance monitoring result and learns that the performance of the AI model does not satisfy the performance requirements, and determines whether to deactivate the AI model. That is, when the value of the prediction accuracy is greater than the threshold, AI model performance indication information is not generated, and no performance monitoring result is reported.

For example, when the system is in the deactivated state of the AI model, the configuration parameter is the first configuration parameter. When the performance metric is a prediction accuracy, when a value of the prediction accuracy is greater than the threshold for prediction accuracy, it indicates that the performance of the AI model satisfies the performance requirements, that is, a current AI model is suitable for the communication environment. The terminal equipment generates the AI model performance indication information (with a bit value of 1) and takes it as the performance monitoring result to indicate that the AI model performance satisfies the performance requirements. In other words, when the value of the prediction accuracy is greater than the threshold for the prediction accuracy, one instance of reporting of the performance monitoring result is triggered. When the network device receives the performance monitoring result and learns that the performance of the AI model satisfies the performance requirements, and determines whether to activate the AI model. That is, when the value of the prediction accuracy is less than the threshold, AI model performance indication information is not generated, and no performance monitoring result is reported.

Reference may be made to the first configuration parameter for a mode of using the third configuration parameter by the terminal equipment, which is not limited in the embodiments of this disclosure.

In some embodiments, the configuration parameters include the threshold and the filter coefficient. The terminal equipment may calculate the value Mₙ of the performance metric, filter the value of the performance metric according to the filter coefficient, compare the filtered value Fₙ with the threshold, and generate the AI model performance indication information according to a comparison result.

For example, when the system is in the activated state of the AI model, the configuration parameter is the second configuration parameter. When the performance metric Mₙ is a prediction error, when a value of the filtered prediction error Fₙ is greater than the threshold for the prediction error, it indicates that the performance of the AI model does not satisfy the performance requirements, that is, a current AI model is no longer suitable for the communication environment. The terminal equipment generates the AI model performance indication information (with a bit value of 1) and takes it as a performance monitoring result to indicate that the performance of the AI model does not satisfy the performance requirements (triggering one instance of reporting of the performance monitoring result). The network device receives the performance monitoring result and learns information on that the performance of the AI model does not satisfy the communication performance requirements, and determines whether to activate the AI model. That is, when the value of the filtered prediction error Fₙ is less than the threshold, AI model performance indication information is not generated, and no performance monitoring result is reported.

For example, when the system is in the deactivated state of the AI model, the configuration parameter is the first configuration parameter. When the performance metric Mₙ is a prediction error, when a value of the filtered prediction error Fₙ is less than the threshold for the prediction error, it indicates that the performance of the AI model satisfies the performance requirements, that is, a current AI model is suitable for the communication environment. The terminal equipment generates the AI model performance indication information (with a bit value of 1) and takes it as a performance monitoring result to indicate that the performance of the AI model satisfies the performance requirements (triggering one instance of reporting of the performance monitoring result). The network device receives the performance monitoring result and learns information on that the performance of the AI model satisfies the communication performance requirements, and determines whether to activate the AI model. That is, when the value of the filtered prediction error Fₙ is greater than the threshold, AI model performance indication information is not generated, and no performance monitoring result is reported.

For example, when the system is in the activated state of the AI model, the configuration parameter is the second configuration parameter. When the performance metric Mₙ is a prediction accuracy, when a value of the filtered prediction accuracy Fₙ is less than the threshold for prediction accuracy, it indicates that the performance of the AI model does not satisfy the performance requirements, that is, a current AI model is no longer suitable for the communication environment. The terminal equipment generates the AI model performance indication information (with a bit value of 1) and takes it as a performance monitoring result to indicate that the performance of the AI model does not satisfy the performance requirements (triggering one instance of reporting of the performance monitoring result). The network device receives the performance monitoring result and learns information on that the performance of the AI model does not satisfy the performance requirements, and determines whether to activate the AI model. That is, when the value of the filtered prediction accuracy is greater than the threshold, AI model performance indication information is not generated, and no performance monitoring result is reported.

For example, when the system is in the deactivated state of the AI model, the configuration parameter is the first configuration parameter. When the performance metric Mₙ is a prediction accuracy, when a value of the filtered prediction accuracy Fₙ is greater than the threshold for prediction accuracies, it indicates that the performance of the AI model satisfies the performance requirements, that is, a current AI model is suitable for the communication environment. The terminal equipment generates the AI model performance indication information (with a bit value of 1) and takes it as a performance monitoring result to indicate that the performance of the AI model satisfies the communication performance requirements (triggering one instance of reporting of the performance monitoring result). The network device receives the performance monitoring result and learns information on that the performance of the AI model satisfies the performance requirements, and determines whether to activate the AI model. That is, when the value of the filtered prediction accuracy is less than the threshold, AI model performance indication information is not generated, and no performance monitoring result is reported.

In the above embodiments, after one instance of reporting of the monitoring result is triggered, Fₙ is set to be 0.

Reference may be made to the first configuration parameter for a mode of using the third configuration parameter by the terminal equipment, which is not limited in the embodiments of this disclosure.

In some embodiments, the configuration parameters include the threshold and the counter. The terminal equipment may calculate the value of the performance metric, compare the calculated value with the threshold, count a comparison result by using the counter, and generate the AI model performance indication information according to a counting result.

For example, when the system is in the activated state of the AI model, the configuration parameter is the second configuration parameter. When the performance metric is a prediction error, if a value of the prediction error Mₙ is greater than the threshold for the prediction error, the counter is increased by 1, when the value of the prediction error is less than the threshold for the prediction error, the counter is decreased by 1. After the value of the performance metric is calculated in a next instance of AI model inference, the operation is repeated, until the counter reaches a set maximum count value, indicating that the performance of the AI model does not satisfy the performance requirements, that is, a current AI model is no longer suitable for the communication environment. The terminal equipment generates the AI model performance indication information (with a bit value of 1) and takes it as a performance monitoring result to indicate that the AI model performance does not satisfy the performance requirements (triggering one instance of reporting of a performance monitoring result). The network device receives the performance monitoring result and learns information on that the performance of the AI model does not satisfy the performance requirements, and determines whether to deactivate the AI model. That is, when the counter has not reached the set maximum count value, AI model performance indication information is not generated, and no performance monitoring result is reported.

For example, when the system is in the deactivated state of the AI model, the configuration parameter is the first configuration parameter. When the performance metric is a prediction error, if a value of the prediction error Mₙ is less than the threshold for the prediction error, the counter is increased by 1, when the value of the prediction error is greater than the threshold for the prediction error, the counter is decreased by 1. After the value of the performance metric is calculated in a next instance of AI model inference, the operation is repeated, until the counter reaches a set maximum count value, indicating that the performance of the AI model satisfies the performance requirements, that is, a current AI model is suitable for the communication environment. The terminal equipment generates the AI model performance indication information (with a bit value of 1) and takes it as a performance monitoring result to indicate that the AI model performance satisfies the performance requirements (triggering one instance of reporting of a performance monitoring result). The network device receives the performance monitoring result and learns information on that the performance of the AI model satisfies the performance requirements, and determines whether to activate the AI model. That is, when the counter has not reached the set maximum count value, AI model performance indication information is not generated, and no performance monitoring result is reported.

For example, when the system is in the activated state of the AI model, the configuration parameter is the second configuration parameter. When the performance metric is a prediction accuracy, if a value of the prediction accuracy Mₙ is less than the threshold for the prediction accuracy, the counter is increased by 1, when the value of the prediction accuracy is greater than the threshold for the prediction accuracy, the counter is decreased by 1. After the value of the performance metric is calculated in a next instance of AI model inference, the operation is repeated, until the counter reaches a set maximum count value, indicating that the performance of the AI model does not satisfy the performance requirements, that is, a current AI model is no longer suitable for the communication environment. The terminal equipment generates the AI model performance indication information (with a bit value of 1) and takes it as a performance monitoring result to indicate that the AI model performance does not satisfy the performance requirements (triggering one instance of reporting of a performance monitoring result). The network device receives the performance monitoring result and learns information on that the performance of the AI model does not satisfy the performance requirements, and determines whether to deactivate the AI model. That is, when the counter has not reached the set maximum count value, AI model performance indication information is not generated, and no performance monitoring result is reported.

For example, when the system is in the deactivated state of the AI model, the configuration parameter is the first configuration parameter. When the performance metric is a prediction accuracy, if a value of the prediction accuracy Mₙ is greater than the threshold for the prediction accuracy, the counter is increased by 1, when the value of the prediction accuracy is less than the threshold for the prediction accuracy, the counter is decreased by 1. After the value of the performance metric is calculated in a next instance of AI model inference, the operation is repeated, until the counter reaches a set maximum count value, indicating that the performance of the AI model satisfies the performance requirements, that is, a current AI model is suitable for the communication environment. The terminal equipment generates the AI model performance indication information (with a bit value of 1) and takes it as a performance monitoring result to indicate that the AI model performance satisfies the performance requirements (triggering one instance of reporting of a performance monitoring result). The network device receives the performance monitoring result and learns information on that the performance of the AI model satisfies the performance requirements, and determines whether to activate the AI model. That is, when the counter has not reached the set maximum count value, AI model performance indication information is not generated, and no performance monitoring result is reported.

In the above embodiments, the counter is reset after one instance of reporting a performance monitoring result is triggered.

Reference may be made to the first configuration parameter for a mode of using the third configuration parameter by the terminal equipment, which is not limited in the embodiments of this disclosure.

In some embodiments, the configuration parameters include the threshold, the filter coefficients and the counter. The terminal equipment may calculate the value of the performance metric, filter the value of the performance metric according to the filter coefficients, compare the filtered value with the threshold, count a comparison result by using the counter, and generate the AI model performance indication information according to a counting result.

For example, when the system is in the activated state of the AI model, the configuration parameter is the second configuration parameter. When the performance metric is a prediction error, when a value of the filtered prediction error Fₙ is greater than the threshold for a prediction error, the counter is increased by 1, and when the value of the filtered prediction error Fₙ is less than the threshold for a prediction error, the counter is decreased by 1. After the value of the performance metric is calculated in a next instance of AI model inference, the operation is repeated, until the counter reaches a set maximum count value, indicating that the performance of the AI model does not satisfy the performance requirements, that is, a current AI model is no longer suitable for the communication environment. The terminal equipment generates the AI model performance indication information (with a bit value of 1) and takes it as a performance monitoring result to indicate that the AI model performance does not satisfy the performance requirements (triggering one instance of reporting of a performance monitoring result). The network device receives the performance monitoring result and learns information on that the performance of the AI model does not satisfy the performance requirements, and determines whether to deactivate the AI model. That is, when the counter has not reached the set maximum count value, AI model performance indication information is not generated, and no performance monitoring result is reported.

For example, when the system is in the deactivated state of the AI model, the configuration parameter is the first configuration parameter. When the performance metric is a prediction error, when a value of the filtered prediction error Fₙ is less than the threshold for the prediction error, the counter is increased by 1, and when the value of the filtered prediction error Fₙ is greater than the threshold for the prediction error, the counter is decreased by 1. After the value of the performance metric is calculated in a next instance of AI model inference, the operation is repeated, until the counter reaches a set maximum count value, indicating that the performance of the AI model satisfies the performance requirements, that is, a current AI model is suitable for the communication environment. The terminal equipment generates the AI model performance indication information (with a bit value of 1) and takes it as a performance monitoring result to indicate that the AI model performance satisfies the performance requirements (triggering one instance of reporting of a performance monitoring result). The network device receives the performance monitoring result and learns information on that the performance of the AI model satisfies the performance requirements, and determines whether to activate the AI model. That is, when the counter has not reached the set maximum count value, AI model performance indication information is not generated, and no performance monitoring result is reported.

For example, when the system is in the activated state of the AI model, the configuration parameter is the second configuration parameter. When the performance metric is a prediction accuracy, when a value of the filtered prediction accuracy Fₙ is less than the threshold for the prediction accuracy, the counter is increased by 1, and when the value of the filtered prediction accuracy Fₙ is greater than the threshold for the prediction accuracy, the counter is decreased by 1. After the value of the performance metric is calculated in a next instance of AI model inference, the operation is repeated, until the counter reaches a set maximum count value, indicating that the performance of the AI model does not satisfy the performance requirements, that is, a current AI model is no longer suitable for the communication environment. The terminal equipment generates the AI model performance indication information (with a bit value of 1) and takes it as a performance monitoring result to indicate that the AI model performance does not satisfy the performance requirements (triggering one instance of reporting of a performance monitoring result). The network device receives the performance monitoring result and learns information on that the performance of the AI model does not satisfy the performance requirements, and determines whether to deactivate the AI model. That is, when the counter has not reached the set maximum count value, AI model performance indication information is not generated, and no performance monitoring result is reported.

For example, when the system is in the deactivated state of the AI model, the configuration parameter is the first configuration parameter. When the performance metric is a prediction accuracy, when a value of the filtered prediction accuracy Fₙ is greater than the threshold for the prediction accuracy, the counter is increased by 1, and when the value of the filtered prediction accuracy Fₙ is less than the threshold for the prediction accuracy, the counter is decreased by 1. After the value of the performance metric is calculated in a next instance of AI model inference, the operation is repeated, until the counter reaches a set maximum count value, indicating that the performance of the AI model satisfies the performance requirements, that is, a current AI model is suitable for the communication environment. The terminal equipment generates the AI model performance indication information (with a bit value of 1) and takes it as a performance monitoring result to indicate that the AI model performance satisfies the performance requirements (triggering one instance of reporting of a performance monitoring result). The network device receives the performance monitoring result and learns information on that the performance of the AI model satisfies the performance requirements, and determines whether to activate the AI model. That is, when the counter has not reached the set maximum count value, AI model performance indication information is not generated, and no performance monitoring result is reported.

In the above embodiments, after one instance of reporting of the performance monitoring result is triggered, the counter is reset, and Fₙ is set to be 0.

Reference may be made to the first configuration parameter for a mode of using the third configuration parameter by the terminal equipment, which is not limited in the embodiments of this disclosure.

### (II) The Network Device Determines Whether the Performance of the AI Model Satisfies the Performance Requirements

In some embodiments, the terminal equipment may calculate the value of the performance metric of the AI model, and filter the value of the performance metric according to the configuration parameters (filter coefficients), in other words, the terminal equipment may calculate the value of the performance metric according to the configuration parameters (filter coefficients), and include the calculated value of the (e.g. filtered) performance metric in a performance monitoring report to the network device.

In some embodiments, the configuration parameters include the filter coefficients, and the terminal equipment may calculate the value Mₙ of the performance metric, filter the value Mₙ of the performance metric according to the filter coefficients to obtain a filtered value Fₙ of the performance metric, and report Fₙ to the network device as a performance monitoring result. After receiving the performance monitoring result, the network device determines whether the performance of the AI model satisfies the performance requirements according to the threshold (and the counter, optionally), and determines whether a current AI model is suitable for a current communication environment to determine whether to activate the AI model or deactivate the AI model or select an AI model or switch the AI model. A specific mode for determining whether the performance of the AI model satisfies the performance requirements is identical to that at the terminal equipment side, which shall not be repeated herein any further.

As described above, the thresholds in the first configuration parameter, the second configuration parameter and the third configuration parameter are identical or different, the filter coefficients in the first configuration parameter, the second configuration parameter and the third configuration parameter are identical or different, and the counters in the first configuration parameter, the second configuration parameter and the third configuration parameter are identical or different.

In addition, the above description is given by taking the performance monitoring results of one AI model as an example, and when multiple AI models are deployed in the terminal equipment, the above methods are also applicable to performance monitoring results of the AI models in the multiple AI models, which shall not be repeated herein any further.

In some embodiments, when multiple AI models are deployed in the terminal equipment, such as when the network device transmits configuration parameters for monitoring performances of multiple AI models, the performance monitoring results further include identifiers of the AI models, so as to distinguish performance monitoring results of different AI models.

In some embodiments, the performance monitoring results are carried by UCI. For example, the AI model performance indication information and/or the value of the performance metric of the AI model and/or the identifier of the AI model may be represented by using a bit sequence of a predetermined number of bits. Information elements may be newly added to existing UCI to carry the performance monitoring results, or existing information elements in existing UCI may carry the performance monitoring results, or new UCI may be designed to carry the performance monitoring results; however, the embodiments of this disclosure are not limited thereto.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

The network device transmits the configuration parameters for monitoring the performance of the AI model to the terminal equipment. Hence, the terminal equipment may generate performance monitoring results according to the configuration parameters, and may effectively monitor the performance of the AI model according to the performance monitoring results, which is helpful to select a beam management mode suitable for current communication environment, thereby reducing system payload and latency.

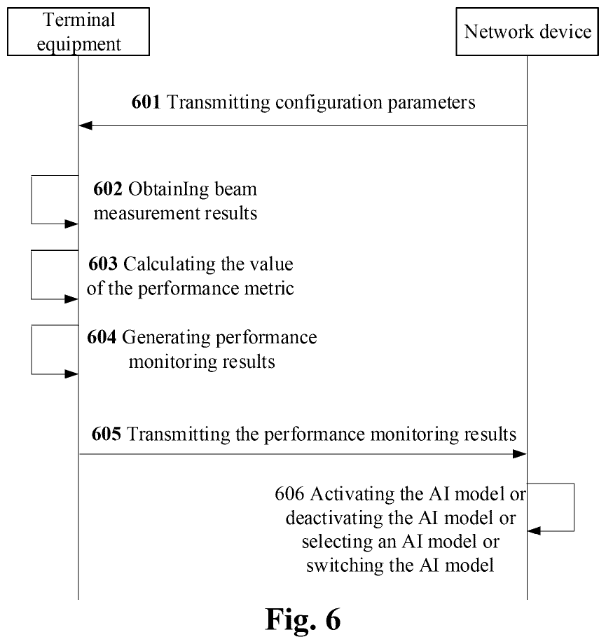

FIG. 6 is a schematic diagram of the information transceiving method of the embodiments of this disclosure. As shown in FIG. 6, the method includes:
601: the network device transmits configuration parameters for monitoring the performance of the AI model to the terminal equipment;
602: the terminal equipment performs beam prediction by using the AI model or performing beam management by using a legacy method to obtain beam measurement results;
603: the terminal equipment calculates the value of the performance metric according to the beam measurement results;
604: the terminal equipment generates performance monitoring results according to the configuration parameters;
605: the terminal equipment reports the performance monitoring results to the network device; and
606: the network device activates the AI model or deactivate the AI model or selects an AI model or switches the AI model according to the performance monitoring results.

In some embodiments, reference may be made to 301-302 and 501-502 for implementations of 601-606, and repeated parts shall not be described herein any further.

### Embodiments of a Third Aspect

The embodiments of this disclosure provide an information transceiving apparatus. The apparatus may be, for example, a terminal equipment, or one or some components or assemblies configured in the terminal equipment. Contents in this embodiment identical to those in the embodiments of the second aspect shall not be described herein any further.

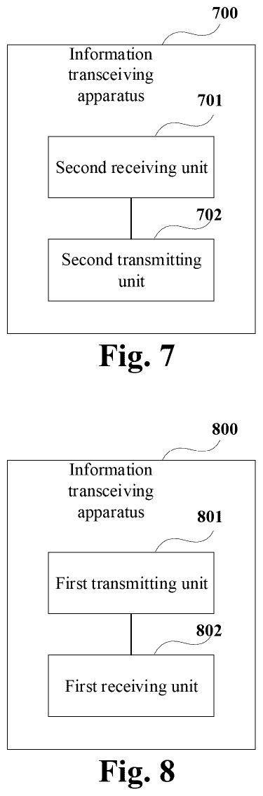

FIG. 7 is a schematic diagram of the information transceiving apparatus of the embodiments of this disclosure. As shown in FIG. 7, an information transceiving apparatus 700 includes:
a second receiving unit 701 configured to receive configuration parameters transmitted by a network device for monitoring performances of one or more AI models; and
a second transmitting unit 702 configured to transmit performance monitoring results of one or more AI models to the network device.

In some embodiments, the performance monitoring results include AI model performance indication information, and/or a value of an AI model performance metric, and/or identifier of an AI model.

In some embodiments, the apparatus further includes:

a first calculating unit (not shown) configured to calculate the value of the AI model performance metric.

In some embodiments, the first calculating unit calculates the value of the performance metric according to the configuration parameters, and the performance monitoring results include the value of the performance metric.

In some embodiments, the apparatus further includes:

a second processing unit (not shown) configured to perform filtering processing on the value of the performance metric according to the configuration parameters (filter coefficient and/or counter) and/or compare the value of the performance metric with the configuration parameters (threshold), and generate the performance monitoring result containing AI model performance indication information according to a result of the filtering processing and/or a result of comparison.

In some embodiments, the second processing unit processes the value of the performance metric according to the configured filter coefficient for the performance metric to generate a value of a filtered performance metric, compares the value of filtered performance metric with a configured threshold for the performance metric, and when the value of the filtered performance metric is greater than the configured threshold for the performance metric, generates the performance monitoring result containing the AI model performance indication information, or when the value of the filtered performance metric is less than the configured threshold for the performance metric, generates the performance monitoring result containing the AI model performance indication information; or,

the second processing unit compares the value of the performance metric with the configured threshold for the performance metric, and when the value of the performance metric is greater than the configured threshold for the performance metric, a counter for counting the monitoring results of the performance metric is increased by 1, when the value of the performance metric is less than the configured threshold for the performance metric, the counter for counting the monitoring results of the performance metric is decreased by 1, and when a value of the counter reaches a maximum count value, the performance monitoring result containing the AI model performance indication information is generated; or when the value of the performance metric is less than the configured threshold for the performance metric, the counter for counting the monitoring results of the performance metric is increased by 1, when the value of the performance metric is greater than the configured threshold for the performance metric, the counter for counting the monitoring results of the performance metric is decreased by 1, and when a value of the counter reaches a maximum count value, the performance monitoring result containing the AI model performance indication information is generated.

In some embodiments, implementations of the second receiving unit 701 and the second transmitting unit 702 correspond to those of 501 and 502, which shall not be described herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the information transceiving apparatus 700 may further include other components or modules, and reference may be made to related techniques for particulars of these components or modules.

Furthermore, for the sake of simplicity, connection relationships between the components or modules or signal profiles thereof are only illustrated in FIG. 7. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

The network device transmits the configuration parameters for monitoring the performance of the AI model to the terminal equipment. Hence, the terminal equipment may generate performance monitoring results according to the configuration parameters, and may effectively monitor the performance of the AI model according to the performance monitoring results, which is helpful to select a beam management mode suitable for current communication environment, thereby reducing system payload and latency.

### Embodiments of a Fourth Aspect

The embodiments of this disclosure provide an information transceiving apparatus. The apparatus may be, for example, a network device, or one or some components or assemblies configured in the network device. Contents in the embodiments identical to those in the embodiments of the first aspect shall not be described herein any further.

FIG. 8 is a schematic diagram of the information transceiving apparatus of the embodiments of this disclosure. As shown in FIG. 8, an information transceiving apparatus 800 includes:
a first transmitting unit 801 configured to transmit configuration parameters for monitoring performances of one or more AI models to a terminal equipment; and
a first receiving unit 802 configured to receive performance monitoring results of one or more AI models transmitted by the terminal equipment.

In some embodiments, the configuration parameters include a threshold for performance metric and/or a filter coefficient for performance metric and/or a counter for counting a monitoring result of a performance metric.

In some embodiments, the performance metric includes a prediction error, and/or a prediction accuracy, and/or a throughput, and/or a frame error rate.

In some embodiments, the prediction error includes a difference between a predicted result of an optimal beam (pair) outputted by an AI model and an actual measured result of the optimal beam (pair), or a difference between a predicted result of a first optimal beam (pair) outputted by an AI model and an actually measured result of a second optimal beam (pair), or an average value of differences between predicted results of multiple beams (pairs) outputted by an AI model and actually measured results of the multiple beams (pairs), or an average value of differences between predicted results of multiple first beams (pairs) outputted by an AI model correspond and measured results of actually measured second optimal beams (pairs) correspond.

In some embodiments, the prediction accuracy includes a probability of whether a first optimal beam (pair) outputted by an AI model is identical to an actually measured second optimal beam (pair), or a probability that a first number of first beams (pairs) outputted by an AI model contain actually measured optimal beams (pairs), or a probability that optimal beams (pairs) outputted by an AI model are contained in a second number of actually measured second beams (pairs).

In some embodiments, the measured result and/or predicted result includes L1-RSRP or SINR.

In some embodiments, the actual measured result is determined according to training data of an AI model or according to actual measured results when an AI model is not applied.

In some embodiments, the apparatus further includes:

a first processing unit (not shown) configured to activate or deactivate or select or switch an AI model according to the performance monitoring results.

In some embodiments, the configuration parameters include a first configuration parameter for determining to activate an AI model, and/or a second configuration parameter for determining to deactivate an AI model, and/or a third configuration parameter for selecting an AI model and/or switching an AI model.

In some embodiments, the first configuration parameter, the second configuration parameter and the third configuration parameter are identical or different.

In some embodiments, configuration parameters for monitoring performances of different AI models are identical or different.

In some embodiments, when the first transmitting unit transmits the configuration parameters for monitoring performances of multiple AI models, the first transmitting unit is further configured to transmit identifiers of AI models to which the configuration parameters correspond, and the performance monitoring results further include identifiers of corresponding AI models.

In some embodiments, the configuration parameters are carried by RRC or an MAC CE or DCI, and the performance monitoring results are carried by UCI.

In some embodiments, the AI model is deployed at a side of the terminal equipment.

In some embodiments, implementations of the first transmitting unit 801 and the second transmitting unit 802 correspond to those of 301 and 302, which shall not be described herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the information transceiving apparatus 800 may further include other components or modules, and reference may be made to related techniques for particulars of these components or modules.

Furthermore, for the sake of simplicity, connection relationships between the components or modules or signal profiles thereof are only illustrated in FIG. 8. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

The network device transmits the configuration parameters for monitoring the performance of the AI model to the terminal equipment. Hence, the terminal equipment may generate performance monitoring results according to the configuration parameters, and may effectively monitor the performance of the AI model according to the performance monitoring results, which is helpful to select a beam management mode suitable for current communication environment, thereby reducing system payload and latency.

### Embodiments of a Fifth Aspect

The embodiments of this disclosure provide a communication system, and reference may be made to FIG. 1, with contents identical to those in the embodiments of the first to the fourth aspects being not going to be described herein any further.

In some embodiments, the communication system 100 may at least include a network device 101 and/or a terminal equipment 102, wherein the network device transmits configuration parameters for monitoring performances of one or more AI models to the terminal equipment, and the network device receives performance monitoring results of one or more AI models transmitted by the terminal equipment.

In some embodiments, reference may be made to the embodiments of the first and second aspects for implementations of the configuration parameters and the performance monitoring results, which shall not be described herein any further.

The embodiments of this disclosure further provide a network device, which may be, for example, a base station. However, this disclosure is not limited thereto, and it may also be another network device.

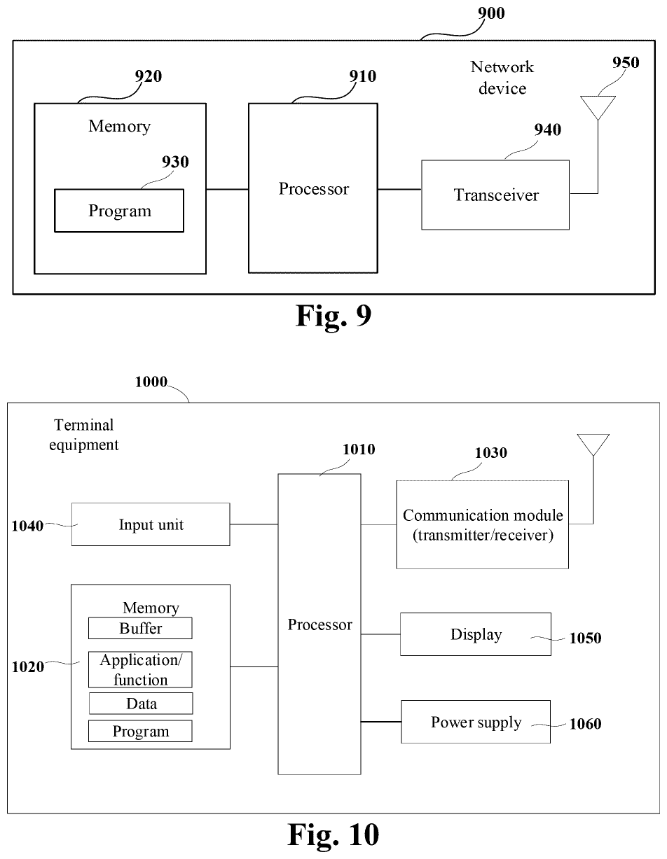

FIG. 9 is a schematic diagram of a structure of the network device of the embodiments of this disclosure. As shown in FIG. 9, a network device 900 may include a processor 910 (such as a central processing unit (CPU)) and a memory 920, the memory 920 being coupled to the processor 910. The memory 920 may store various data, and furthermore, it may store a program 930 for information processing, and execute the program 930 under control of the processor 910.

For example, the processor 910 may be configured to execute a program to carry out the information transceiving method described in the embodiments of the first aspect. For example, the processor 910 may be configured to execute the following control: transmitting configuration parameters for monitoring performances of one or more AI models to a terminal equipment; and receiving performance monitoring results of one or more AI models transmitted by the terminal equipment.

Furthermore, as shown in FIG. 9, the network device 900 may include a transceiver 940, and an antenna 950, etc. Functions of the above components are similar to those in the related art, and shall not be described herein any further. It should be noted that the network device 900 does not necessarily include all the parts shown in FIG. 9, and furthermore, the network device 900 may include parts not shown in FIG. 9, and the related art may be referred to.

The embodiments of this disclosure further provide a terminal equipment; however, this disclosure is not limited thereto, and it may also be another equipment.

FIG. 10 is a schematic diagram of the terminal equipment of the embodiments of this disclosure. As shown in FIG. 10, a terminal equipment 1000 may include a processor 1010 and a memory 1020, the memory 1020 storing data and a program and being coupled to the processor 1010. It should be noted that this figure is illustrative only, and other types of structures may also be used, so as to supplement or replace this structure and achieve a telecommunications function or other functions.

For example, the processor 1010 may be configured to execute a program to carry out the information transceiving method as described in the embodiments of the second aspect. For example, the processor 1010 may be configured to execute the following control: receiving configuration parameters transmitted by a network device for monitoring performances of one or more AI models; and transmitting performance monitoring results of one or more AI models to the network device.

As shown in FIG. 10, the terminal equipment 1000 may further include a communication module 1030, an input unit 1040, a display 1050, and a power supply 1060; wherein functions of the above components are similar to those in the related art, which shall not be described herein any further. It should be noted that the terminal equipment 1000 does not necessarily include all the parts shown in FIG. 10, and the above components are not necessary. Furthermore, the terminal equipment 1000 may include parts not shown in FIG. 10, and the related art may be referred to.

Embodiments of this disclosure provide a computer program, which, when executed in a terminal equipment, causes the terminal equipment to carry out the information transceiving method as described in the embodiments of the second aspect.

Embodiments of this disclosure provide a computer storage medium, including a computer program, which causes a terminal equipment to carry out the information transceiving method as described in the embodiments of the second aspect.

Embodiments of this disclosure provide a computer program, which, when executed in a network device, causes the network device to carry out the information transceiving method as described in the embodiments of the first aspect.

Embodiments of this disclosure provide a computer storage medium, including a computer program, which causes a network device to carry out the information transceiving method as described in the embodiments of the first aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

As to implementations containing the above embodiments, following supplements are further disclosed.

1. An information transceiving method, applicable to a network device, characterized in that the method includes:
transmitting configuration parameters for monitoring performances of one or more AI models by the network device to a terminal equipment; and
receiving, by the network device, performance monitoring results of one or more AI models transmitted by the terminal equipment.

2. The method according to supplement 1, wherein the configuration parameters include a threshold for performance metric and/or a filter coefficient for performance metric and/or a counter for counting a monitoring result of a performance metric.

3. The method according to supplement 2, wherein the performance metric includes a prediction error, and/or a prediction accuracy, and/or a throughput, and/or a frame error rate.

4. The method according to supplement 3, wherein the prediction error includes a difference between a predicted result of an optimal beam (pair) outputted by the AI model and an actual measured result of the optimal beam (pair), or a difference between a predicted result of a first optimal beam (pair) outputted by the AI model and an actually measured result of a second optimal beam (pair), or an average value of differences between predicted results of multiple beams (pairs) outputted by the AI model and actually measured results of the multiple beams (pairs), or an average value of differences between predicted results of multiple first beams (pairs) outputted by an AI model and actually measured results of second optimal beams (pairs).

5. The method according to supplement 3, wherein the prediction accuracy includes a probability of whether a first optimal beam (pair) outputted by the AI model is identical to an actually measured second optimal beam (pair), or a probability that a first number of first beams (pairs) outputted by the AI model contain actually measured optimal beams (pairs), or a probability that optimal beams (pairs) outputted by the AI model are contained in a second number of actually measured second beams (pairs).

6. The method according to supplement 4, wherein the measured result and/or predicted result include L1-RSRP or SINR.

7. The method according to supplement 4, wherein the actual measured results are determined according to training data of the AI model or according to actual measured results when the AI model is not applied.

8. The method according to supplement 1, wherein the method further includes:
activating or deactivating the AI model or selecting an AI model or switching the AI model by the network device according to the performance monitoring results.

9. The method according to supplement 8, wherein the configuration parameters include a first configuration parameter used to determine to activate an AI model, and/or a second configuration parameter used to determine to deactivate an AI model, and/or a third configuration parameter used to select an AI model and/or switch the AI model.

10. The method according to supplement 9, wherein the first configuration parameter, the second configuration parameter and the third configuration parameter are identical or different.

11. The method according to supplement 1, wherein configuration parameters used to monitor performances of different AI models are identical or different.

12. The method according to supplement 1, wherein when the network device transmits the configuration parameters for monitoring performances of multiple AI models, the network device further transmits identifiers of AI models corresponding to the configuration parameters, and the performance monitoring results further include identifiers of the corresponding AI models.

13. The method according to supplement 1, wherein the configuration parameters are carried by RRC or an MAC CE or DCI, and the performance monitoring results are carried by UCI.

14. The method according to supplement 1, wherein the AI model is deployed at a side of the terminal equipment.

15. An information transceiving method, applicable to a terminal equipment, characterized in that the method includes:
receiving, by the terminal equipment, configuration parameters transmitted by a network device for monitoring performances of one or more AI models; and
transmitting performance monitoring results of one or more AI models by the terminal equipment to the network device.

16. The method according to supplement 15, wherein the performance monitoring results include AI model performance indication information, and/or a value of an AI model performance metric, and/or identifier of an AI model.

17. The method according to supplement 15, wherein the method further includes:
calculating the value of the AI model performance metric by the terminal equipment.

18. The method according to supplement 17, wherein the terminal equipment calculates the value of the performance metric according to the configuration parameters, and the performance monitoring results include the value of the performance metric.

19. The method according to supplement 17, wherein the method further includes:
performing filtering processing on the value of the performance metric according to the configuration parameters (filter coefficient and/or counter) and/or comparing the value of the performance metric with the configuration parameters (threshold), and generating the performance monitoring result containing AI model performance indication information according to a result of the filtering processing and/or a result of comparison, by the terminal equipment.

20. The method according to supplement 19, wherein the terminal equipment processes the value of the performance metric according to the configured filter coefficient for the performance metric to generate a value of a filtered performance metric, compares the value of filtered performance metric with a configured threshold for the performance metric, and when the value of the filtered performance metric is greater than the configured threshold for the performance metric, generates the performance monitoring result containing the AI model performance indication information, or when the value of the filtered performance metric is less than the configured threshold for the performance metric, generates the performance monitoring result containing the AI model performance indication information; or,
the terminal equipment compares the value of the performance metric with the configured threshold for the performance metric, and when the value of the performance metric is greater than the configured threshold for the performance metric, a counter for counting the monitoring results of the performance metric is increased by 1, when the value of the performance metric is less than the configured threshold for the performance metric, the counter for counting the monitoring results of the performance metric is decreased by 1, and when a value of the counter reaches a maximum count value, the performance monitoring result containing the AI model performance indication information is generated; or when the value of the performance metric is less than the configured threshold for the performance metric, the counter for counting the monitoring results of the performance metric is increased by 1, when the value of the performance metric is greater than the configured threshold for the performance metric, the counter for counting the monitoring results of the performance metric is decreased by 1, and when a value of the counter reaches a maximum count value, the performance monitoring result containing the AI model performance indication information is generated.

21. A network device, including a memory and a processor, the memory storing a computer program, and the processor being configured to execute the computer program to carry out the method as described in any one of supplements 1-14.

22. A terminal equipment, including a memory and a processor, the memory storing a computer program, and the processor being configured to execute the computer program to carry out the method as described in any one of supplements 15-20.

23. A communication system, including the network device as described in supplement 21 and/or the terminal equipment as described in supplement 22.

1. An information transceiving apparatus, applicable to a network device, the apparatus comprising:
a first transmitter configured to transmit configuration parameters for monitoring performances of one or more AI models to a terminal equipment; and
a first receiver configured to receive performance monitoring results of the one or more AI models transmitted by the terminal equipment.

2. The apparatus according to claim 1, wherein the configuration parameters comprise a threshold for performance metric and/or a filter coefficient for performance metric and/or a counter for counting a monitoring result of a performance metric.

3. The apparatus according to claim 2, wherein the performance metric comprises a prediction error, and/or a prediction accuracy, and/or a throughput, and/or a frame error rate.

4. The apparatus according to claim 3, wherein the prediction error comprises a difference between a predicted result of an optimal beam (pair) outputted by an AI model and an actual measured result of the optimal beam (pair), or a difference between a predicted result of a first optimal beam (pair) outputted by an AI model and an actually measured result of a second optimal beam (pair), or an average value of differences between predicted results of multiple beams (pairs) outputted by an AI model and actually measured results of the multiple beams (pairs), or an average value of differences between predicted results of multiple first beams (pairs) outputted by an AI model and actually measured results of a second optimal beams (pairs).

5. The apparatus according to claim 3, wherein the prediction accuracy comprises a probability of whether a first optimal beam (pair) outputted by an AI model is identical to an actually measured second optimal beam (pair), or a probability that a first number of first beams (pairs) outputted by an AI model contain actually measured optimal beams (pairs), or a probability that optimal beams (pairs) outputted by an AI model are contained in a second number of actually measured second beams (pairs).

6. The apparatus according to claim 4, wherein the measured result and/or predicted result comprises L1-RSRP or SINR.

7. The apparatus according to claim 4, wherein the actual measured result is determined according to training data of an AI model or according to actual measured results when an AI model is not applied.

8. The apparatus according to claim 1, the apparatus further comprising:
first processor circuitry configured to activate or deactivate or select or switch an AI model according to the performance monitoring results.

9. The apparatus according to claim 8, wherein the configuration parameters comprise a first configuration parameter for determining to activate an AI model, and/or a second configuration parameter for determining to deactivate an AI model, and/or a third configuration parameter for selecting an AI model and/or switching an AI model.

10. The apparatus according to claim 9, wherein the first configuration parameter, the second configuration parameter and the third configuration parameter are identical or different.

11. The apparatus according to claim 1, wherein configuration parameters for monitoring performances of different AI models are identical or different.

12. The apparatus according to claim 1, wherein when the first transmitter transmits the configuration parameters for monitoring performances of multiple AI models, the first transmitter is further configured to transmit identifiers of AI models to which the configuration parameters correspond, and the performance monitoring results further include identifiers of corresponding AI models.

13. The apparatus according to claim 1, wherein the configuration parameters are carried by RRC or an MAC CE or DCI, and the performance monitoring results are carried by UCI.

14. The apparatus according to claim 1, wherein the AI model is deployed at a side of the terminal equipment.

15. An information transceiving apparatus, applicable to a terminal equipment, the apparatus comprising:
a second receiver configured to receive configuration parameters transmitted by a network device for monitoring performances of one or more AI models; and
a second transmitter configured to transmit performance monitoring results of the one or more AI models to the network device.

16. The apparatus according to claim 15, wherein the performance monitoring results comprise AI model performance indication information, and/or a value of an AI model performance metric, and/or identifier of an AI model.

17. The apparatus according to claim 15, the apparatus further comprising:
a first calculator configured to calculate a value of the AI model performance metric.

18. The apparatus according to claim 17, wherein the first calculator calculates the value of the performance metric according to the configuration parameters, and the performance monitoring results include the value of the performance metric.

19. The apparatus according to claim 17, the apparatus further comprising:
second processor circuitry configured to perform filtering processing on the value of the performance metric according to the configuration parameters (filter coefficient and/or counter) and/or compare the value of the performance metric with the configuration parameters (threshold), and generate the performance monitoring result containing AI model performance indication information according to a result of the filtering processing and/or a result of comparison.

20. The apparatus according to claim 19, wherein the second processor circuitry processes the value of the performance metric according to the configured filter coefficient for the performance metric to generate a value of a filtered performance metric, compares the value of filtered performance metric with a configured threshold for the performance metric, and when the value of the filtered performance metric is greater than the configured threshold for the performance metric, generates the performance monitoring result containing the AI model performance indication information, or when the value of the filtered performance metric is less than the configured threshold for the performance metric, generates the performance monitoring result containing the AI model performance indication information; or,
the second processor circuitry compares the value of the performance metric with the configured threshold for the performance metric, and when the value of the performance metric is greater than the configured threshold for the performance metric, a counter for counting the monitoring results of the performance metric is increased by 1, when the value of the performance metric is less than the configured threshold for the performance metric, the counter for counting the monitoring results of the performance metric is decreased by 1, and when a value of the counter reaches a maximum count value, the performance monitoring result containing the AI model performance indication information is generated; or when the value of the performance metric is less than the configured threshold for the performance metric, the counter for counting the monitoring results of the performance metric is increased by 1, when the value of the performance metric is greater than the configured threshold for the performance metric, the counter for counting the monitoring results of the performance metric is decreased by 1, and when a value of the counter reaches a maximum count value, the performance monitoring result containing the AI model performance indication information is generated.
